(19) United States
(12) Patent Application Publication
(10) Pub. No.: US 2025/0143428 A1
(43) Pub. Date: May 8, 2025

(54) PEN HOLDER, SYSTEM OF A PEN HOLDER AND AT LEAST TWO PENS AND USE OF A PEN HOLDER

(71) Applicant: Bleispitz GmbH, Oberhaching (DE)

(72) Inventor: Enno MIEDL, Oberhaching (DE)

(21) Appl. No.: 18/938,901

(22) Filed: Nov. 6, 2024

(30) Foreign Application Priority Data
Nov. 8, 2023 (DE) 10 2023 130 992.7

(51) Int. Cl. A45C 11/34; A45F 5/02

(52) U.S. Cl. CPC A45C 11/34; A45F 5/021

(57) ABSTRACT

A pen holder is provided for storing a pen or marker, the pen holder comprising a one-part or multi-part base body that extends in a longitudinal direction and delimits a receiving space for at least partially receiving the pin. The base body includes an insertion opening for introducing the pen into the receiving space at a first end of the longitudinal direction. The pen holder further comprises at least one sealing portion formed or insertable in the receiving space. The sealing portion or the sealing portions is/are provided and designed to receive and make sealing contact with at least a first pen having a first larger diameter and a second pen having a second smaller diameter; or the sealing portion can be adapted to the diameter of the pen to receive and make sealing contact with the pen.

### BACKGROUND

The present disclosure relates to a pen holder for storing a pen or marker, in particular a felt-tip pen or paint marker, and to a system of the pen holder and the felt-tip pen or paint marker as well as to a use of the pen holder.

### PRIOR ART

In crafts and on construction sites, different pens such as a carpenter's pencil are in daily use to carry out marking work and to take notes. In doing so, it is of particular importance that the pen is easy to reach and to use single-handed so as to ensure access to the pen even if a user's second hand holds a tool.

In addition, the pen shall be accommodated so that the pen can be prevented from being lost/misplaced, as particularly pens lying around get quickly lost during use on the construction site.

For solving these problems, pen holders as they are known from DE 695 06 392 T2, for example, have become established on the market. Those pen holders can be fastened and fixed by a clip to a pants or folding rule pocket or a belt of the user and enable the user to access the pen directly, preferably single-handed.

It is a drawback of those pen holders that the pen holder, particularly for felt-tip pens or paint markers which have to be protected against drying of the writing tip and in which it is particularly important that the writing tip is stored substantially capsuled airtightly to prevent the writing tip and, thus, the pen from drying, is specifically adapted to a concrete pen type. Hence, if the pen still gets lost or is damaged or dries, the user has to buy the identical type again so that he/she can continue to use the pen holder. Otherwise, the user takes the risk that the new pen will quickly dry.

To avoid this, when changing the type of pen also a new pen holder that is adapted to the new type of pen has to be purchased.

It is a further drawback that the user needs different holders for different activities, such as for taking measurements on construction sites for which a writing pen is required and for marking work on construction sites for which a marker such as a deep-hole marker is used. This increases a logistic effort for the user, as the user either has to take along several holders or has to consider before getting to the construction site which activities he/she will execute and, consequently, which particular holder will be required.

### SUMMARY OF THE DISCLOSURE

It is therefore the object of the present disclosure to eliminate or at least reduce the drawbacks of prior art. Concretely, it is the object of the present disclosure to provide a solution for transporting and accessing a pen which allows safe transport for different types of pens, particularly for different felt-tip pens and paint markers, while preventing said pens from drying.

This object is achieved by a pen holder according to claim 1, a system of the pen holder and at least one felt-tip pen and/or at least one paint marker according to the independent claim and by a use of a pen holder according to the independent claim. Advantageous developments are claimed in the subclaims and/or disclosed and described as follows.

Concretely, the object is achieved by a pen holder for storing a pen or marker, particularly a felt-tip pen and/or paint marker and/or deep-hole marker, comprising a preferably sleeve-shaped one-piece or multi-piece base body which extends in a longitudinal direction and delimits a receiving space for at least partially receiving the pen, the base body including, at a first end of the longitudinal direction or longitudinal extension, an insertion opening for introducing the pen into the receiving space. The pen holder comprises at least one sealing portion formed or insertable in the receiving space. The sealing portion(s) is/are provided and designed to receive and make (radially) sealing contact with at least a first pen having a first larger diameter and a second pen having a second smaller diameter, i.e. pens of different diameter. Alternatively, or additionally, the sealing portion can be adapted to the diameter of the pen, preferably by a changing device, to receive and make (radially) sealing contact with the pen and/or different pens by means of different sealing portions.

As a matter of course, the different pens shall be received successively or alternately by the pen holder and shall not be positioned simultaneously in the latter.

In other words, the object is achieved by the pen holder that is provided and designed to reversibly receive (exactly) one pen. The pen holder has a base body which extends, preferably at least partially cylindrically, in the longitudinal direction. Alternatively, or additionally, the base body can have a partially conical and/or partially frustoconical design. Accordingly, the pen holder preferably has a (by far) larger extension in the longitudinal direction than in a width direction oriented normal to the longitudinal direction. The base body preferably can be sleeve-shaped or can be designed in sleeve shape. That is, the base body may have a kind of tube geometry closed on one side with a relatively thin wall. The base body and/or the wall of the base body delimits the receiving space of the pen holder. The base body can be one-piece/one-part or multi-piece/multi-part, i.e. can be made of one part or of several parts.

The receiving space is accessible/connected to the environment surrounding the pen holder by the insertion opening. The insertion opening is formed at one of the ends (at the first of the two ends) of the pen holder in the longitudinal direction. In particular, the insertion opening can be formed on an end face/front side of the base body or can substantially form the end face/front side of the pen holder. The insertion opening is the opening through which the pen can be introduced/inserted/pushed/slid at least partially into the receiving space. Preferably, the insertion opening is the only opening which connects the receiving space to the environment surrounding the pen holder.

In the receiving space, the at least one sealing portion is arranged. The at least one sealing portion is provided and designed to make radially circumferentially sealing contact with the pen inserted in the receiving space through the insertion opening, wherein the sealing portion(s) can make sealing contact with at least two, such as two or more than two, different pen geometries.

In yet other words, the sealing portion can make radially circumferentially sealing contact with both the first pen having the first large diameter and the second pen having the second smaller diameter.

Moreover, embodiments are conceivable in which the sealing portion can make radially sealing contact with more than two pens and/or pen types and/or pen diameters. For example, the sealing portion can make radially circumferentially sealing contact with three, four, five or more pen types having different pen diameters.

The sealing portion can be a coherent sealing portion. Alternatively, the sealing portion can be in the form of segments. As a further alternative, the sealing portion can be designed in several parts spaced apart in the longitudinal direction. In other words, the sealing portion alternatively can be formed of plural individual sealing portions spaced apart from each other. In this case, it can also be said that several sealing portions, for example in the form of several seal rings, are provided.

In a configuration as a coherent sealing portion, the sealing portion can include an (elastic) tube or funnel geometry tapering, preferably linearly, from the insertion opening in the longitudinal direction. In other words, the sealing portion can have or be a tapered sealing geometry.

In an alternative configuration, the sealing portion can have plural sealing segments arranged sequentially one behind the other in the longitudinal direction, each sealing segment being provided and designed to seal, i.e. to make radially circumferentially sealing contact with, a defined diameter or a defined diameter range. The sequentially arranged sealing segments can be arranged one behind the other without spacing in the longitudinal extension of the pen holder. There can be formed and/or arranged two, three, four or more sealing segments sequentially in the longitudinal extension of the pen holder.

Alternatively, the sequentially arranged sealing segments can be arranged in the pen holder being spaced apart one behind the other in the longitudinal direction. Preferably, the defined diameters/diameter ranges, i.e. the diameters or diameter ranges in which the respective sealing segments seal the pen, of the sequential sealing segments are tapered/reduced starting from the insertion opening.

Alternatively, the object is achieved by the pen holder with the sealing portion, wherein the sealing portion can be adapted/adjusted to the diameter of the pen, preferably by a replaceable/switchable changing device/adapter device, to make radially sealing contact with the pen or the different pens having the different diameters by means of different sealing portions.

In other words, the changing device is designed to insert or make insertable different sealing portions, i.e. sealing portions of different defined diameters, into the receiving space of the pen holder. The different sealing portions can be a fixed part of the changing device, for example in the form of a drum or a magazine or a grid. As an alternative, the different sealing portions can be designed separately from the changing device and can be inserted into the receiving space via the changing device.

The pen holder can be designed with a locking device to reversibly fix the different sealing portions in the pen holder. For example, the pen holder can include at least one set screw, one bayonet lock, one clamping lock or any further appropriate fastener.

In the case of intended use of the pen holder, the pen is inserted into the pen holder without the (supplied) cap of the pen which protects the pen, when not in use, against drying, to allow quick access to the pen.

Also, embodiments are conceivable in which the pen cap can be introduced into the receiving space via the changing device and the sealing portion is part of the pen cap. Optionally, the pen cap can be fixed in the pen holder and, resp., in the receiving space of the pen holder by means of the locking device.

By designing the pen holder with appropriate sealing portions, the pen holder can sealingly receive different pens, i.e. pens having different diameters, or can be adapted to the different pens to sealingly receive them. Such a design of the pen holder can help the pen holder to sealingly receive a number of different pen types and pen diameters so that the pen holder can be used in a more flexible manner.

In one aspect, the at least one sealing portion can be formed on a sealing element (formed separately from the base body), wherein the sealing element can be inserted, preferably reversibly, into the receiving space.

For example, the sealing element formed separately from the base body can be the pen cap which is provided and designed to close the pen.

In other words, the at least one sealing portion is formed on the sealing element designed separately and, thus, materially separated from the base body. The sealing element including the sealing portion is or can be inserted in the receiving space.

Preferably, plural sealing elements, i.e. more than one sealing element, can be provided and/or designed. The plural sealing elements, such as in the form of seal rings, can be arranged sequentially in the longitudinal direction in the receiving space. Alternatively, the sealing element can be introduced into the receiving space and/or replaced depending on the pen/pen type/pen diameter.

By designing the at least one sealing portion separately on the sealing element, the base body and the sealing portion can be made of different materials. In this way, the base body can be made, for example, of a harder more resistant plastic material, thereby improving the protection of the pen and increasing the life cycle of the pen holder, and the sealing element having the sealing portion can be made of a softer plastic material, thereby improving the sealing of the pen in the pen holder and allowing for a tolerance compensation when sealing the pen.

Further, the separate design of the sealing element and the pen holder can help reduce a complexity of the geometry of the pen holder resulting in a reduction of manufacturing costs. Furthermore, the sealing element comprising the sealing portion can be replaced, when the sealing portion is worn or damaged or other pen diameters are to be inserted into the pen holder so that the sealing of the pen can be maintained over the complete life cycle of the pen holder, or the life cycle of the pen holder can be considerably increased.

Alternatively, it is also preferred, however, when the sealing portion is part of the base body and is particularly formed integrally with the base body or at least part of the base body. In this case, for example in a two-component injection molding process, the base body or the part of the base body can be made of a harder more resistant plastic material, and the sealing portion can be made of a softer more flexible plastic material.

The sealing portion and, resp., the sealing element can have a monotonically tapering geometry extending in the longitudinal direction in the mounted state. In other words, a cross-sectional area of the sealing portion or the sealing element can remain constant or decrease in the longitudinal direction.

The sealing element can be provided and designed to make radially sealing contact with more than two pens and/or pen types and/or pen diameters. For example, the sealing element can make radially circumferentially sealing contact with three, four, five or more pen types having different pen diameters.

In a further aspect, the sealing portion can have or be at least one elastic sealing edge which can be elastically deformable when the pen is introduced into the receiving space.

In other words, the sealing portion can include the at least one elastic sealing edge, preferably in the form of a radially inwardly and/or radially outwardly projecting sealing lip. The sealing edge may be elastically deformable so that the sealing edge adapts to/abuts on/fits snugly to an outer contour/circumferential contour of the pen or adapts to/abuts on/fits snugly to an inner contour of the pen holder. In the inserted state, i.e. in the state in which the pen is introduced at least partially in the receiving space of the pen holder, the sealing edge can radially circumferentially contact the outer contour of the pen.

Such an elastic sealing edge can help improve snug fit of the sealing portion to the pen so that scratches or other damage to a surface of the pen as they are unavoidable in use on construction sites, as well as engravings and imprints in the surface of the pen can be compensated by the sealing portion and the tightness can be guaranteed. Further, an elastic sealing edge also enables sealing of pens having a non-circular cross-section, i.e. a hexagonal cross-section or an oval cross-section, for example. In addition, the elastic sealing edge can help seal a (larger) diameter range as the elastic sealing edge can adapt to the diameter of the pen within a defined range. Moreover, the pen can be reversibly fixed in the pen holder by an elastic clamping force of the elastic sealing edge acting upon the pen, and the pen can be prevented from falling out of the holder, or at least a probability of falling out can be reduced.

Alternatively, or additionally, in the sealing portion at least one rubber-type sealing rim or any other sealing made of rubber can be formed or can form the sealing portion.

Further alternatively, or additionally, at least one O-ring can be formed in the sealing portion or can form the sealing portion. In particular, several O-rings having different diameters can be formed in the sealing portion or can form the sealing portion.

In another aspect, at least one pen cap stop can be formed in the receiving space between the sealing portion and the insertion opening.

In other words, the receiving space can include the pen cap stop, preferably in the form of an edge or a step protruding/projecting radially inwardly from the wall of the base body.

As an alternative, the pen cap stop can be formed of a plurality of lugs or projections spread around the inner circumference of the wall and protruding radially inwardly from the wall of the base body.

Such a pen cap stop can help introduce/insert the pen, particularly in the form of the paint marker, with the attached pen cap into the pen holder, for example to shake the paint marker together with the pen holder for activation. The pen cap stop prevents the pen cap from damaging and/or displacing and/or upsetting the sealing portion which is arranged starting from the insertion opening in the longitudinal direction behind the pen cap stop, when shaking the paint marker for activation.

In another aspect, the sealing portion can divide the receiving space in the longitudinal extension into a sealing space which is provided and designed to airtightly receive at least a writing tip of the pen or a pen section comprising the writing tip, and into a guiding space facing the insertion opening.

In other words, the receiving space can be divided, when the pen is inserted, by the sealing portion into an airtightly closed sealing space and a guiding space communicating with the environment. The guiding space can extend starting from the insertion opening to the sealing portion in the longitudinal direction of the receiving space. The sealing space can extend starting from the sealing portion to a (closed) end of the base body in the receiving space.

Particularly by forming an airtight sealing space, a life cycle of the pen in the pen holder can be considerably increased. Concretely, the pin can be prevented, when not in use, from drying by ambient air. By dividing the receiving space into the sealing space and the guiding space by the sealing portion, the size/volume of the sealing space can be selected by a predetermined positioning of the sealing portion in the receiving space so that a life cycle of the pen is maximized and an ease of use is sufficiently high and a great variety of different pens can be accommodated in the pen holder.

In another aspect, the sealing space can comprise a receptacle for a marking tip of a deep-hole marker.

In other words, the sealing space can have an extended substantially needle-shaped recess that is provided and designed to receive the marking tip of the deep-hole marker.

In another aspect, the guiding space/receiving space can include at least one centering element that is provided and designed to (radially) center the pen in the receiving space.

In other words, the guiding space can include at least the one centering element which extends inwardly (also) radially starting from the wall of the base body or a rim of the insertion opening. The centering element can be designed so that it contacts the pen during the inserting operation, preferably uniformly and/or regularly, around the circumference of the pen so that the pen is inserted centered into the sealing portion and is held centered in the sealing portion.

Such a centering element can help improve the sealing of the sealing portion, as wrong insertion of the pen into the pen holder is at least impeded/can be prevented. This also improves the handling for the user who can insert the pen single-handed into the pen holder without having to look and can be sure that the pen is received and sealed in the pen holder as predefined. Moreover, the centering element can help reduce a transverse force exerted upon the sealing portion by the pen, resulting in an increase in the life cycle of the sealing portion.

In another aspect, the centering element can have a number of elastic spring elements which can be distributed evenly around an inner circumference of the guiding space.

In other words, the centering element can be or include the number of elastic spring elements. The elastic spring elements can (also) extend in a direction radially inwards starting from the wall of the base body.

A spring force of the spring elements can act radially inwardly. Preferably, at least three spring elements are distributed evenly around the circumference of the base body. Preferably, the spring elements are in the form of leaf springs, specifically as leaf springs mounted on one side.

Alternatively, designs as disk springs, diaphragm springs, annular springs or the like are possible when appropriately fixed to the wall of the base body.

Further alternatively, a design of the centering element with a number of centering wings or centering ribs or a centering disk formed at the insertion opening and having a centering hole is conceivable. The centering hole is arranged on an (imaginary) central fiber of the pen holder extending in the longitudinal direction of the pen holder.

In another aspect, a pen cap receptacle, preferably in the form of a step, can be formed at a second end remote from the first end and, resp., the first end face in the longitudinal extension and/or at a second end face.

In other words, the pen cap receptacle can be formed at the closed end of the, preferably sleeve-shaped, base body. The pen cap receptacle can particularly be designed as the step, viz. a stepped outer diameter reduction of the pen holder.

The pen cap can be safely stored by such a pen cap receptacle while using the pen holder. This can prevent the pen cap from getting lost.

In another aspect, the base body and the sealing portion can be made of, preferably different, plastic materials.

In other words, the base body can be made of a first, preferably relatively hard, plastic material, and the sealing portion can be made of a second, preferably softer, plastic material.

In a further aspect, the base body can be made of polypropylene (PP).

In a further aspect, the sealing portion and/or the sealing element including the sealing portion can be made of an elastomer such as rubber, or of a thermoplastic elastomer.

Alternatively, the sealing insert can be made of polyethylene (PE).

In another aspect, the base body can be multi-part, in particular two-part.

In another aspect, on a portion remote from the insertion opening, the pen holder can have an adapter device for inserting/introducing/engaging different sealing portions.

In a further aspect, the adapter device may have an adapter member which is drum-shaped/turret-shaped/magazine-shaped and is rotatably mounted on an axis of rotation oriented normal to the longitudinal extension of the pen holder, wherein, starting from an outer circumference of the adapter device, preferably radially inwardly formed, specifically preferably blind hole-shaped or through hole-shaped writing tip receptacles are formed. Each of the writing tip receptacles can have at least one sealing portion having respective different diameters or for pens having different diameters.

In another aspect, the adapter device can include a plurality of adapter members, wherein the adapter members (alternately depending on the pen) can be introduced into the receiving space transversely to the longitudinal extension of the pen holder through an adapter member insertion opening. Preferably, each of the adapter members can have two or four different ones of the writing tip receptacles.

In another aspect, the adapter members can be reversibly received/fixed/positioned via a pen-shaped receptacle in the pen holder.

The object of the present disclosure is further achieved by a system of a pen holder according to any one of the foregoing aspects and a first pen, preferably felt-tip pen or paint marker, having a first larger diameter and a second pen, preferably felt-tip pen or paint marker, having a second smaller diameter. The sealing portion makes (radially circumferential) sealing contact with the first pen in a state inserted in the pen holder, and the sealing portion makes (radially circumferential) sealing contact with the second pen in the state inserted in the pen holder. It is understood that only one pen, viz. the first pen or the second pen, is inserted at a time in the pen holder.

As a matter of course, the pen can also be a deep-hole marker or the like.

In other words, the object is achieved by the system of the pen holder and the felt-tip pen and/or paint marker and/or deep-hole marker, wherein an inside diameter of the sealing portion is adjusted to more than an outer diameter of more than one felt-tip pen or paint marker, or the inside diameter of the sealing portion can be adapted to the outer diameter of different felt-tip pens or paint markers.

Of course, the system can comprise more than two different pens. The system can comprise three, four, five or more different pens having different pen diameters.

In one aspect, the sealing portion can have a first sealing segment that is provided and designed to make radially circumferentially sealing contact with the first pen and can have a second sealing segment that is provided and designed to make radially circumferentially sealing contact with the second pen, the second sealing segment being spaced farther from the insertion opening in the longitudinal direction than the first sealing segment.

In other words, the sealing portion can include several, at least two, different sealing segments having different inside diameters. The different sealing segments can be formed or arranged, when mounted, in the pen holder in the longitudinal direction sequentially one behind the other.

Of course, more than two sealing segments can be formed in the sealing portion. For example, three, four or five different sealing segments can be formed in the sealing portion.

In another aspect, a first inside diameter of the first sealing segment can be smaller than the first diameter of the first pen and larger than the second diameter of the second pen.

In another aspect, a second inside diameter of the second sealing segment can be smaller than the second diameter of the second pen.

By adjusting the diameters of the different sealing segments to the diameters of the different pens in this way, it can be ensured that circumferentially sealing contact can be made with each of the pens in the sealing portion. In addition, this prevents or at least stops a pen having a large diameter from damaging a sealing segment having a smaller diameter due to overstretching or spreading.

In another aspect, the base body may include at least one grip element, preferably in the form of ears, that extends at or close to the first end, at least partially, substantially radially outwardly away from the base body wall.

In other words, the base body can have at least one grip element. The grip element is provided and designed to be grasped by the user. Concretely, the grip element is provided and designed to be grasped by at least one finger of the user (for each grip element).

The at least one grip element can be formed at the first end, viz. adjacent to/in the vicinity of the insertion opening. The at least one grip element has a, preferably substantially flat or plate-shaped, extension radially outwardly away from the base body wall. In yet other words, the at least one grip element can preferably extend normal to a central fiber of the base body of the pen holder.

Due to the design of at least one grip element, the user can easily remove the pen from the pen holder. Concretely, the user can grasp the pen, for example with an index finger and a middle finger, and press with a thumb of the same hand against the grip element to overcome a latching force by which the pen is latched in the pen holder and, resp., in the sealing portion.

In other words, the grip element can form a force application point for the user's finger. In this way, the user can remove the pen single-handed from the pen holder, even if the pen is latched tightly in the pen holder.

Further, due to the design of the at least one grip element on the pen holder, the user can insert and latch the pen easily in the pen holder. Concretely, the user can insert the pen through the insertion opening into the receiving space and, as soon as the latching resistance generated by the sealing portion, for example, is reached, can grip behind the grip element with his/her index finger and/or his/her middle finger and/or his/her ring finger, for example, and can press, e.g. by a palm or by his/her thumb, against the pen, in particular against a rear side of the pen remote from the writing tip, to latch the pen in the pen holder.

In one aspect, the grip element can extend substantially plate-shaped normal to the longitudinal direction and, in a plan view oriented in the longitudinal direction, can have a sickle shape with at least one first radius at a radially externally arranged circumferential edge.

The object of the present disclosure is further achieved by a use of a pen holder according to any one of the foregoing aspects for alternately receiving and sealingly contacting at least a first pen having a first larger diameter and a second pen having a second smaller diameter.

The pen holder may include a, preferably sleeve-shaped, one-part or multi-part base body that delimits a receiving space for receiving at least partially a pen, and a sealing portion that is formed in the receiving space or is inserted in the receiving space to seal a first pen portion, which contains at least one writing tip, of a first pen having a first larger diameter and a first pen portion, which contains at least one writing tip, of a second pen having a second smaller diameter alternately radially circumferentially against an environment surrounding the pen holder.

As a matter of course, the sealing portion can seal more than a first pen portion and a second pen portion with the respective writing tip. In this way, the sealing portion can be designed to seal even a third pen portion of a third pen having an even larger diameter and/or a fourth pen portion of a fourth pen having an even smaller diameter radially circumferentially against the environment surrounding the pen holder.

### BRIEF DESCRIPTION OF THE FIGURES

FIG. 1 is a perspective view of a pen holder according to the disclosure in a first embodiment.

FIG. 2 is a lateral view of the pen holder according to the disclosure in the first embodiment.

FIG. 3 is a section view of the pen holder according to the disclosure of the first embodiment.

FIG. 4 is a perspective view of a first portion of a base body of the pen holder of the first embodiment.

FIG. 5 is a perspective view of a second portion of the base body of the pen holder of the first embodiment.

FIG. 6 is a perspective view of a sealing insert of the pen holder of the first embodiment.

FIG. 7 is a lateral view of the sealing insert of the first embodiment.

FIG. 8 is a plan view of the sealing insert of the first embodiment.

FIG. 9 is a perspective view of the pen holder according to the disclosure in a second embodiment.

FIG. 10 is a section view across a drum of the pen holder of the second embodiment.

FIG. 11 is a perspective view of the pen holder according to the disclosure in a third embodiment.

FIG. 12 is a representation of three sealing elements for the pen holder of the third embodiment.

FIG. 13 is a perspective view of the pen holder according to the disclosure in a fourth embodiment.

FIG. 14 is a section view across the sealing element for the pen holder of the fourth embodiment.

FIG. 15 is a perspective view of the pen holder according to the disclosure in a fifth embodiment.

FIG. 16 is a tilted representation of the sealing element for the pen holder of the fifth embodiment.

FIG. 17 is a representation of the pen holder according to the disclosure of the fifth embodiment in two lateral views rotated by 90° against each other, and of a centering element in the form of a centering ring in two different perspective views.

FIG. 18 is a lateral view of a first pen in a closed state.

FIG. 19 is a lateral view of the first pen in an opened state.

FIG. 20 is a lateral view of a second pen in a closed state.

FIG. 21 is a lateral view of the second pen in an opened state.

FIG. 22 is a lateral view of the holder according to the disclosure with an inserted pen.

### DESCRIPTION OF THE EMBODIMENTS

Hereinafter embodiments of the present disclosure are described on the basis of the associated Figures.

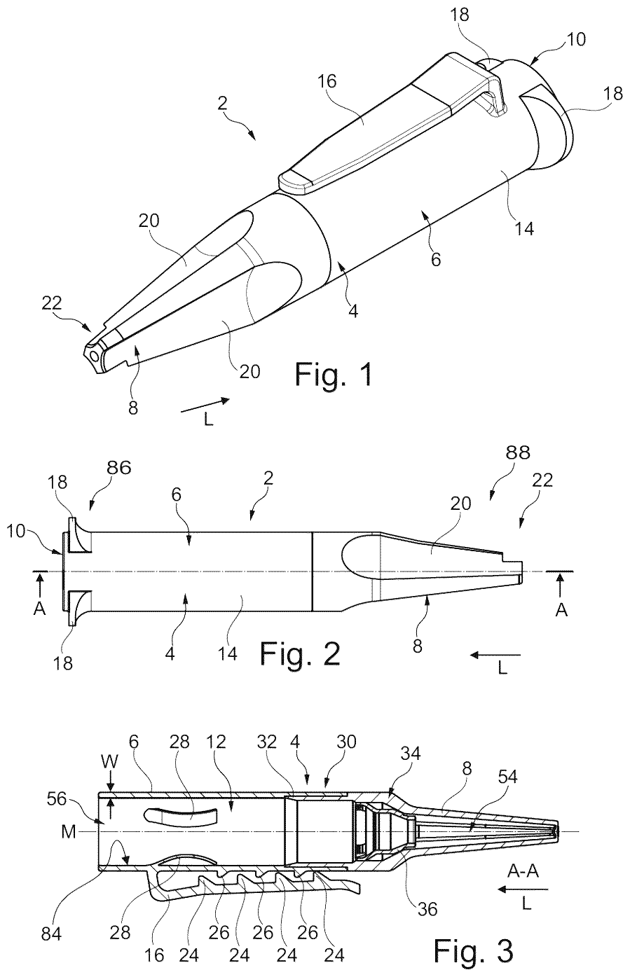

FIG. 1 and FIG. 2 illustrate a pen holder 2 according to the disclosure for storing a pen 76, 78, in particular a felt-tip pen or a paint marker, viz. a pen 76, 78 whose writing tip 80, 82 can dry when in contact with air.

The pen holder 2 comprises a base body 4 which extends in a longitudinal direction L. The base body 4 comprises a first substantially tubular portion 6 and a second tapered portion 8. The first portion 6 is formed in one piece. The first portion 6 of the base body 4 includes a substantially circular insertion opening 10 at a first end face. The insertion opening 10 is provided and designed to insert the pen 76, 78 at least partially into a receiving space 12 (see FIG. 3).

On an outer lateral surface 14 of the first portion 6 of the base body 4, a fastening clip/retaining clip 16 is provided and designed to fix the pen holder 2 to a belt, a (pants or rule) pocket or to any other appropriate object of a user of the pen holder 2.

Adjacent to the insertion opening 10, starting from the lateral surface 14, two ears 18 extend radially opposite to each other away from the base body 4. The ears 18 are provided and designed to be grasped by the user so as to facilitate insertion or removal of the pen 76, 78 into/from the pen holder 2.

The second portion 8 of the base body 4 has recesses 20 in the form of tube segments which are provided and designed to reduce a rotation of the pen holder 2 inside the user's pocket, for example. Furthermore, the recesses 20 act as recessed grips which can be grasped when operated two-handed.

At a second end face of the second portion 8 of the base body 4, a pen cap receptacle 22 is designed in the form of a step. A pen cap 90 of the pen 76, 78 can be attached to and latched with the pen cap receptacle 22 so that the pen cap 90 is safely stored and put away when using the pen holder 2 (see FIG. 22).

FIG. 3 illustrates a section view of the pen holder 2 in a section plane A-A shown in FIG. 2. The first portion 6 of the base body 4 has a substantially constant wall thickness W. The retaining clip 16 is formed integrally with the first portion 6 of the base body 4. First barbs 24 are formed at the retaining clip 16 on a side facing the first portion 6. In the longitudinal direction L, second barbs 26 are formed alternately opposite to the first barbs 24 on the base body 4. The first barbs 24 and the second barbs 26 fix the pen holder 2 safely via the fastening clip 16 and prevent the pen holder 2 from slipping or falling out of a user's pocket, for example.

The first portion 6 is designed with elastic spring elements 28 spread evenly around the (inner) circumference 84 toward the receiving space 12. In the embodiment shown here, three elastic spring elements 28 are distributed around the circumference 84 of the first portion 6. Also, embodiments are conceivable in which more than three elastic spring elements 28 or less than three elastic spring elements 28 are distributed around the circumference 84. The elastic spring elements 28 constitute a centering element of the pen holder 2 and make sure that the pen 76, 78 is guided and/or held along a central fiber M of the pen holder 2.

The first portion 6 and the second portion 8 are connected/coupled to each other in a connecting area 30. The connecting area 30 can be a force-fit and/or form-fit connection between the first portion 6 and the second portion 8, the second portion 8 being partially inserted in the first portion 6. In other words, the first portion 6 and the second portion 8 can be glued, crimped, shrunk, welded or the like with each other. For this purpose, in the connecting area 30, the second portion 8 is designed to have a reduced outer diameter so that an outer contour of the pen holder 2 is formed substantially continuously in the connecting area 30. As a matter of course, also the first portion 6 can be partially inserted in the second portion 8, or the first portion 6 and the second portion 8 can be connected to each other at contacting end faces.

Further, embodiments are conceivable in which the connecting area 30 is designed as a reversibly connected connecting area 30 so that the latter can be connected and separated by the user. Preferably, the connecting area 30 can be designed with a bayonet lock for this purpose.

In the embodiment shown here, the second portion 8 forms a pen cap stop 32 at an end of the second portion 8 facing the insertion opening 10. The pen cap stop 32 is a peripheral stepped tapering/step of the receiving space 12. The pen cap stop 32 is provided and designed to act as a stop when the pen 76, 78, specifically a paint marker, is introduced into the pen holder 2 with pen cap 90 being attached so as to safely shake the paint marker in the pen holder 2 for activation.

In an alternative embodiment, the pen cap stop 32 can be formed in the first portion 6 or in an extension of the second portion 8.

In the second portion 8, particularly on a receiving area 34 of the second portion 8, a sealing element 36 is arranged. In the embodiment shown here, the sealing element 36 is an insert which is inserted in the second portion 8. The sealing element will be illustrated in detail below on the basis of FIGS. 6 to 8.

The sealing element 36 can be clamped, glued, crimped, screwed or fixed in any other way (by means of frictional force, for example) in the second portion 8.

The sealing element 36 can contact the second portion 8 extensively, linearly and/or punctually. Preferably, the sealing element 36 contacts the second portion 8 at points/positions different from each other.

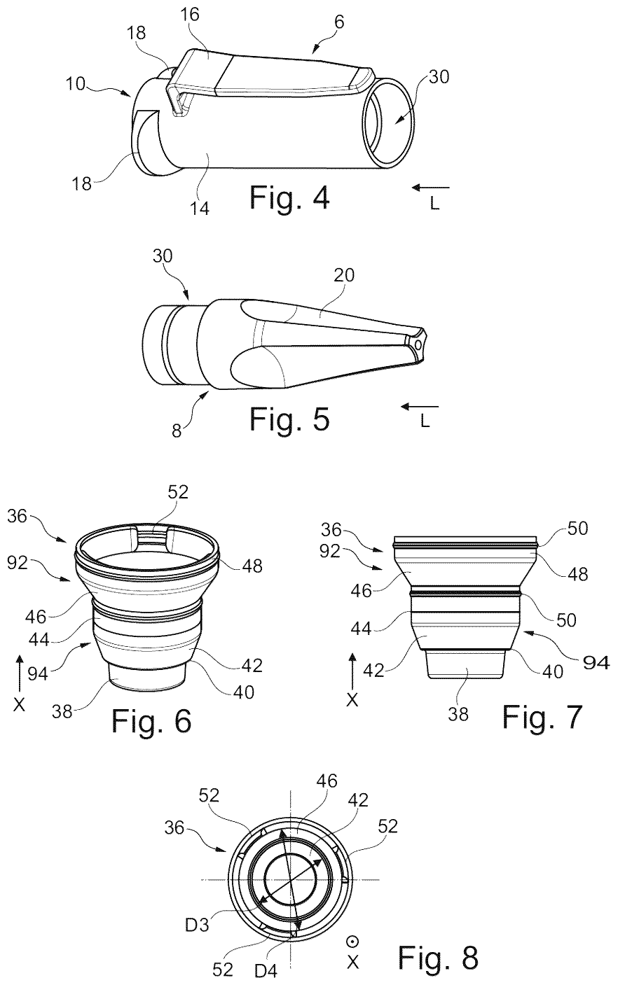

FIG. 4 illustrates the first portion 6 in a dismantled state. FIG. 5 illustrates the second portion 8 in a dismantled state. For assembly of the pen holder 2, the sealing element 36 is inserted into the second portion 8 starting from the end of the second portion 8 at which the connecting area 30 is formed, until the sealing element 36 is arranged in the receiving area 34. After that, the first portion 6 is slid in the longitudinal direction L onto the second portion 8 so that the first portion 6 and the second portion 8 extensively overlap in the connecting area 30. Optionally, an adhesive may be applied in the connecting area 30.

Alternatively, as above-described, the connecting area 30 can be in the form of a reversibly detachable connecting area 30. In this way, the sealing element 36 can be replaced by the user at will according to the described assembly.

FIG. 6, FIG. 7 and FIG. 8 illustrate the sealing element 36 in different views. The sealing element 36 shown here is provided and designed to receive pens 76, 78 having two different diameters D1, D2 in a sealing manner.

The sealing element 36 is made in one piece of an elastic plastic material. The sealing element 36 is substantially made up of a sequence of cylindrical tube segments and conical tube segments arranged in a first direction X. In the assembled state of the pen holder 2, the first direction X corresponds to the longitudinal direction L.

The sealing element 36 comprises a first cylindrical tube segment 38. The first cylindrical tube segment 38 is provided and designed to extensively contact the second portion 8 of the pen holder 2 and to seal between the second portion 8 and the sealing element 36 as well as to fix the sealing element 36 in the second portion 8 by frictional adhesion.

In the first direction X, a first conical tube segment 42 is connected to the first cylindrical tube segment 38 via a first shoulder 40. The first conical tube segment 42 widens conically in the first direction X. A second cylindrical tube segment 44 is connected to the first conical tube segment 42 in the first direction X. The first conical tube segment 42 and the second cylindrical tube segment 44 form a second sealing segment 94 for a second pen 78 having a second smaller diameter D2.

In other words, the first conical tube segment 42 and the second cylindrical tube segment 44 are provided and designed to make radially circumferentially sealing contact with the second pen 78 having the second smaller diameter D2.

In the first direction X, the second conical tube segment 46 is connected to the second cylindrical tube segment 44. Further, in the first direction X, the third cylindrical tube segment 48 is connected to the second conical tube segment 46. The second conical tube segment 46 and the third cylindrical tube segment 48 form a first sealing segment 92 for a first pen having a first larger diameter D1.

In other words, the second conical tube segment 46 and the third cylindrical tube segment 48 are provided and designed to make a radially circumferentially sealing contact with the first pen 76 having the first larger diameter D1.

On each of the second cylindrical tube segment 44 and the third cylindrical tube segment 48, at an outer circumference there are formed circumferential sealing edges 50 which seal and/or fix the sealing element 36 against the second portion 8.

In the third cylindrical tube segment 48, recesses which increase a radial elasticity of the third cylindrical tube segment 48 are formed to be evenly distributed around an inner circumference.

The sealing element 36 divides the receiving space 12 in the longitudinal direction L into a sealing space 54 and the guiding space 56 (see FIG. 3). The sealing space 54 is a space in which the writing tip 80, 82 of the pen 76, 78 is arranged in the pen holder 2 when the pen 76, 78 is inserted. The sealing element 36 seals, on the one hand, on the inner circumference against the pen 76, 78 and, on the other hand, on the outer circumference against the second portion 8 so that the sealing space 54 is sealed airtightly against an environment of the pen 76, 78 and the writing tip 80, 82 of the pen 76, 78 does not dry in the state inserted in the pen holder 2. The pen 76, 78 is additionally fixed in the pen holder 2 by the friction between the pen 76, 78 and the sealing element 36.

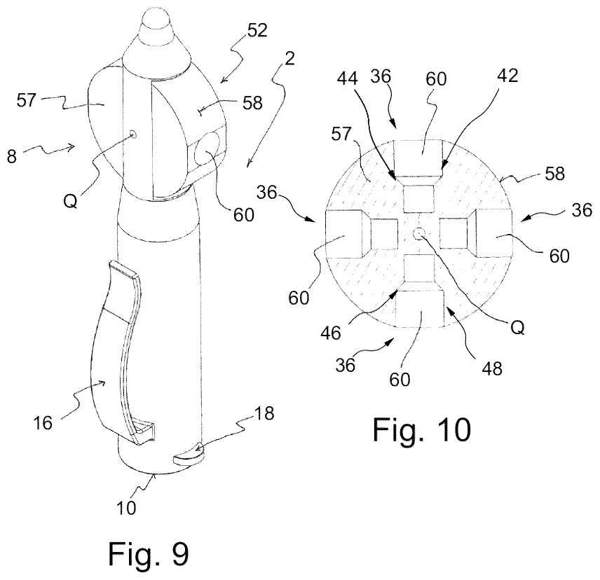

In the following, alternative embodiments, particularly with changing devices for different sealing elements 36, will be described on the basis of FIGS. 9 to 17.

For reasons of clarity, the general structure of the pen holder 2 shall not be described again. All explanations and descriptions which were made in the foregoing concerning the first embodiment, have to be applied or are applicable, as far as they are technically reasonable, to the following alternative embodiments.

FIG. 9 illustrates a first alternative embodiment of the pen holder 2 for the pen 76, 78. The pen holder 2 is formed with a changing device 52 on the second portion 8. In the first alternative embodiment, the changing device 52 is a disk-shaped drum 57. The drum 57 is rotatable in the pen holder 2 about a transverse axis Q that is oriented normal to the central fiber M of the pen holder 2. The sealing portion engaging the pen 76, 78 can be replaced by rotating the drum 57. In other words, the sealing portion can be adapted to the pen 76, 78 by rotation of the drum 57.

As illustrated in FIG. 9 and in the section view of FIG. 10, blind holes 60 are formed on an outer circumference 58 of the drum 57. The blind holes 60 are sealing portions in the form of sealing elements 36 and/or sealing spaces 54 for different pens and pen diameters, or comprise corresponding sealing elements 36. The blind holes 60 are evenly distributed around the outer circumference 58 of the drum 57. Each of the sealing elements 36 of the first alternative embodiment includes one of the conical tube segments 42, 46 and one of the cylindrical tube segments 44, 48 which constitute the sealing portion.

As an alternative, the sealing element 36 in the first alternative embodiment can be designed to be replaceable corresponding to FIGS. 6 to 8.

By rotation of the drum 57, the sealing element 36 which is in the receiving space 12 can be changed so that the pen holder 2 can be adapted to different pens 76, 78 and/or pen diameters D1, D2. In the first alternative embodiment shown here, four different sealing elements 36 are formed in blind holes 60 of the drum 57. As a matter of course, also more than four or less than four different sealing elements 36 can be formed in the blind holes 60 of the drum 57.

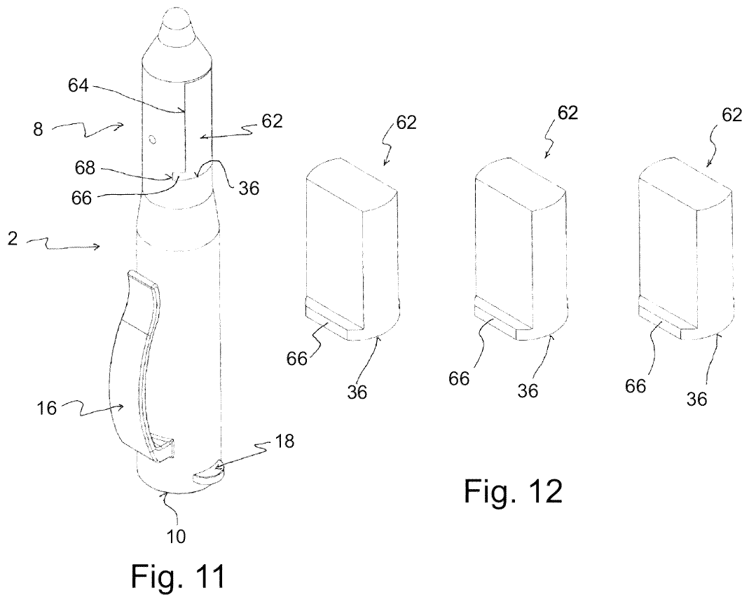

FIG. 11 illustrates the pen holder 2 in a second alternative embodiment. In the second alternative embodiment, different sealing portions such as in the form of different sealing elements 36 are designed on adapter elements 62 which are insertable into the second portion 8 and which are shown in FIG. 12. The respective sealing element 36 is formed starting from a front side of the adapter element 62.

Alternatively, the sealing portions, preferably in the form of cylindrical and conical tube segments 42, 44, 46, 48, may be designed directly in the adapter elements 62, i.e. without a separately formed sealing element 36 in the adapter element 62.

In order to introduce the respective adapter element 62 designed with the sealing element 36 matching the pin 76, 78 or tube segments 42, 44, 46, 48 into the pen holder 2, an adapter element mount 64 is formed in the second portion 8 of the pen holder 2. The adapter elements 62 can be inserted into the adapter element mount 64 in a direction normal to the central fiber M of the pen holder 2.

The adapter elements 62 are designed with ribs 66 which can be inserted into rib mounts 68 of the adapter element mount 64 so that the adapter element 62 is positioned in a defined manner in the adapter element mount 64.

According to the second alternative embodiment, the changing device 52 is realized by the adapter element mount 64 in combination with at least two adapter elements 62 having sealing portions adapted to different diameters so that even according to this embodiment the sealing portion can be adapted to the diameter of the pen 76, 78 by a changing device 52 in order to receive and make sealing contact with the respective pen 76, 78.

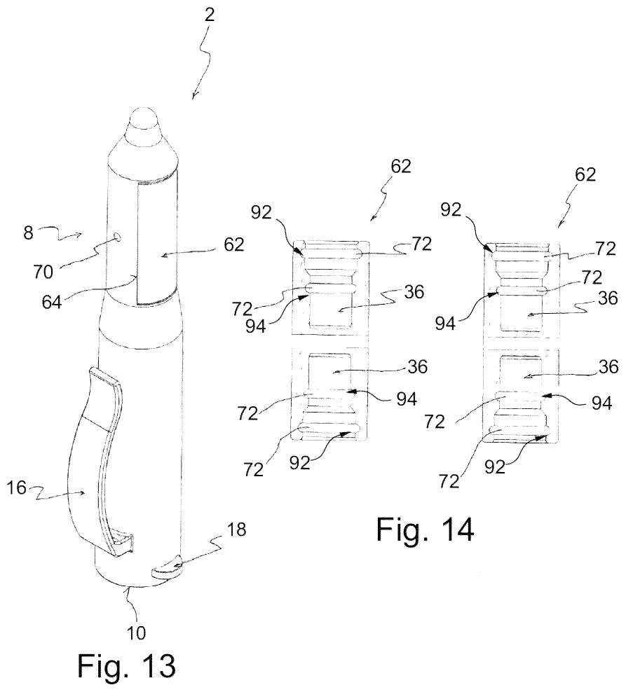

FIG. 13 illustrates the pen holder 2 in a third alternative embodiment. The third alternative embodiment substantially corresponds to the second alternative embodiment. Therefore, in the following only differences of the third alternative embodiment from the second alternative embodiment shall be discussed.

In the third alternative embodiment, each of the adapter elements 62 is designed with two different sealing elements 36. Each of the two different sealing elements 36 is formed in the end faces of the adapter element 62 so that the adapter element 62 can be inserted into the adapter element mount 64 offset/rotated by 180°. Thus, the third embodiment is designed without ribs 66 and without the rib mount 68. For fixation of the adapter element 62 in the adapter element mount 64, a connecting pin 70 is formed in the adapter element mount 64. As an alternative to the design of sealing elements 36, also in the third alternative embodiment the sealing portions, preferably in the form of cylindrical and conical tube segments 42, 44, 46, 48, can be formed directly in the adapter elements 62, viz. without a separate sealing element 36 in the adapter element 62.

In FIG. 14, the adapter element 62 of the third alternative embodiment is illustrated in a section view. Each of the sealing elements 36 has two sealing grooves 72, wherein each of the peripheral sealing grooves 72 is formed to seal a pen diameter D1, D2. Thus, each of the adapter elements 62 of the third alternative embodiment can seal four different pen diameters D1, D2. The sealing grooves constitute the sealing portion and/or the sealing segments 92, 94 of the third alternative embodiment.

Of course, the embodiment with sealing grooves 72 illustrated here into which O-rings (not shown) can be introduced can also be applied to each of the other embodiments.

According to the third alternative embodiment, the changing device 52 is realized by the adapter element mount 64 in combination with at least one adapter element 62 that includes at least two sealing portions adapted to different diameters. Therefore, according to this embodiment, the sealing portion can also be adapted by a changing device 52 to the diameter of the pen 76, 78 in order to receive and make sealing contact with the respective pen 76, 78. According to the third alternative embodiment, also on an adapter element 62 there are provided two sealing portions each of which can receive and make sealing contact with two pens 76, 78 having different diameters.

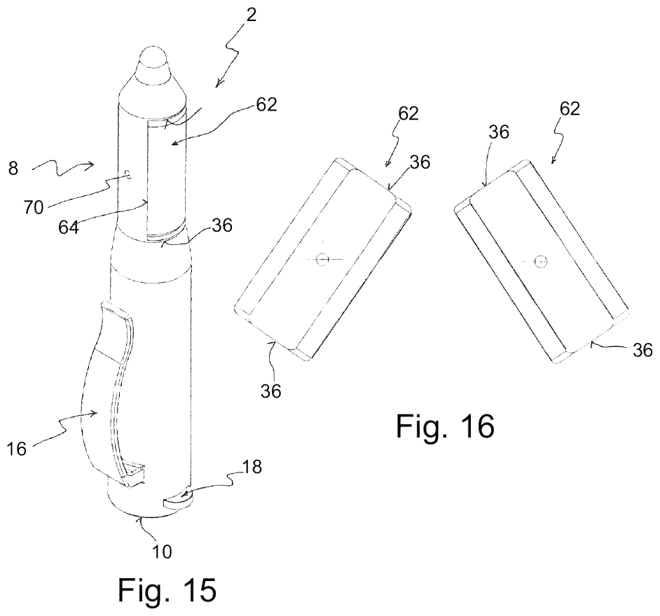

FIG. 15 illustrates the pen holder 2 in a fourth alternative embodiment, and FIG. 16 illustrates the adapter element 62 of the fourth alternative embodiment. The fourth alternative embodiment shown in FIGS. 15 and 16 substantially corresponds to the third alternative embodiment so that, hereinafter, only differences of the fourth alternative embodiment from the third alternative embodiment will be discussed.

In the fourth alternative embodiment, the sealing element 36 is a through hole in the adapter element 62. The exact design of the sealing element 36 is not shown here. Each of the described embodiments of the sealing element 36 is applicable to the fourth alternative embodiment, wherein the blind hole has to be replaced with the through hole, where necessary.

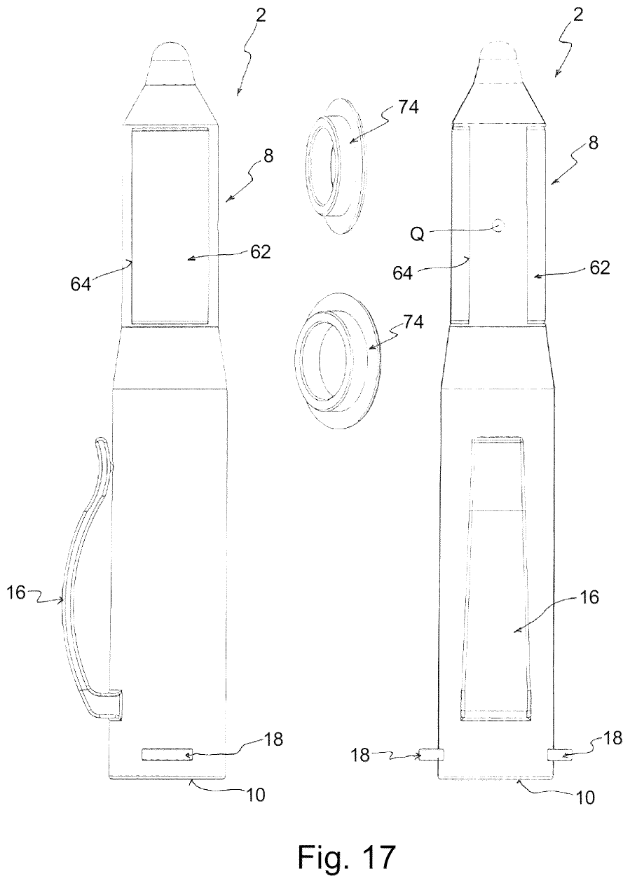

FIG. 17 illustrates two lateral views rotated against each other by 90 angular degrees of an embodiment of the pen holder 2 as well as two perspective views of a centering ring 74 constituting an alternative embodiment of the centering element. The centering ring 74 may be attached to or introduced into the insertion opening 10 or may be formed integrally with the base body 4 on the insertion opening 10 so that, when the pen 76, 78 is inserted into the pen holder 2, the pen 76, 78 is guided on the central fiber M and is inserted into the sealing element 36 in a predetermined manner.

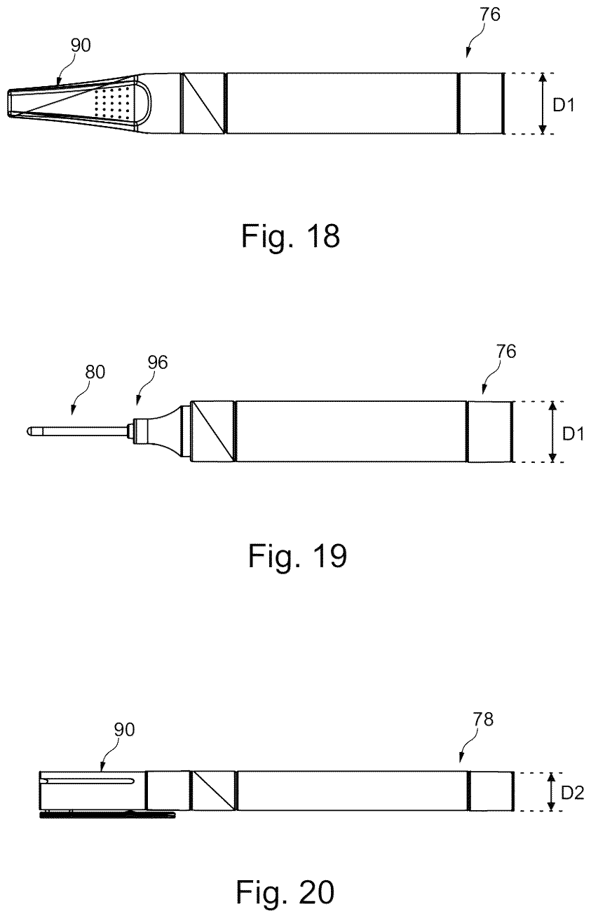

FIG. 18 illustrates the first pen 76 having the first larger diameter D1 in a lateral view in a state in which the pen cap 90 is closed. FIG. 19 illustrates the first pen 76 in an opened state.

The first pen 76 is a deep-hole marker with the first needle-shaped writing tip 80. The pen holder 2 is provided and designed to receive the first needle-shaped writing tip 80 airtightly in the sealing space 54.

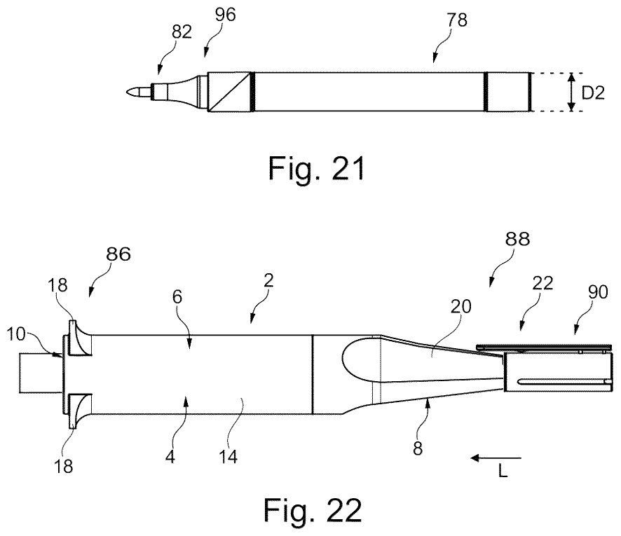

FIG. 20 illustrates the second pen 78 having the second smaller diameter D2 in a lateral view in a state in which the pen cap 90 is closed. FIG. 21 illustrates the second pen 78 in an opened state.

The second pen 78 is a felt-tip marker having the second writing tip 82. The pen holder 2 is provided and designed to receive the second writing tip 82 airtightly in the sealing space 54.

FIG. 22 exemplifies the second pen 78 received in the pen holder 2. The second pen 78 is held by the spring elements 28 on the central fiber of the pen holder 2. The second pen 78 is received being radially sealed in the second sealing segment 94 of the sealing element 36. In other words, the second writing tip 82 is received in the sealing space 54. The pen cap 90 is received by force fit or form fit on the pen cap receptacle 22 which is formed at the second end 88 of the pen holder.

1. A pen holder for storing a pen or marker, the pen holder comprising:
a one-part or multi-part base body that extends in a longitudinal direction and delimits a receiving space for at least partially receiving the pin,
wherein the base body includes an insertion opening for introducing the pen into the receiving space at a first end of the longitudinal direction,
the pen holder further comprising at least one sealing portion formed or insertable in the receiving space, wherein:
the sealing portion or the sealing portions is/are provided and designed to receive and make sealing contact with at least a first pen having a first larger diameter and a second pen having a second smaller diameter; or
the sealing portion can be adapted to the diameter of the pen to receive and make sealing contact with the pen.

2. The pen holder according to claim 1, wherein the sealing portion is formed on a sealing element provided separately from the base body, wherein the sealing element can be introduced into the receiving space.

3. The pen holder according to claim 2, wherein the sealing element is a pen cap for reversibly closing the pen or is formed in a pen cap.

4. The pen holder according to claim 1, wherein the sealing portion has or is at least one elastic sealing edge which is elastically deformable when introducing the pen into the receiving space.

5. The pen holder according to claim 1, wherein a pen cap stop is formed between the sealing portion and the insertion opening.

6. The pen holder according to claim 1, wherein the sealing portion divides the receiving space in the longitudinal direction into a sealing space which is provided and designed to airtightly receive at least one writing tip of the pen, and a guiding space facing the insertion opening.

7. The pen holder according to claim 6, wherein the guiding space includes a centering element which is provided and designed to center the pen in a radial direction of the pen in the guiding space.

8. The pen holder according to claim 7, wherein the centering element has a number of elastic spring elements which are evenly distributed around an inner circumference of the guiding space.

9. The pen holder according to claim 1, wherein, at a second end remote from the first end in the longitudinal extension, a pen cap receptacle is formed which is provided and designed to receive a pen cap of the first pen and/or of the second pen.

10. The pen holder according to claim 1, wherein the pen holder includes a latching or locking unit which is provided and designed to reversibly fix the sealing portion in or on the pen holder.

11. The pen holder according to claim 1, wherein the sealing portion or the sealing portions is/are provided and designed to receive and make sealing contact with two or more than two, such as three, four or five, pens having different diameters.

12. A system comprising:
a pen holder according to claim 1; and
at least a first pen having a first larger diameter and a second pen having a second smaller diameter,
wherein the sealing portion makes sealing contact with the first pen when the latter is inserted in the pen holder, and the sealing portion makes sealing contact with the second pen when the latter is inserted in the pen holder.

13. The system according to claim 12, wherein the sealing portion has or forms a first sealing segment which is provided and designed to make radially circumferentially sealing contact with the first pen, and has or forms a second sealing segment which is provided and designed to make radially circumferentially sealing contact with the second pen, the second sealing segment being spaced farther from the insertion opening in the longitudinal direction than the first sealing segment.

14. The system according to claim 13, wherein a first inside diameter of the first sealing segment is smaller than the first diameter of the first pen and larger than the second diameter of the second pen; and
a second inside diameter of the second sealing segment is smaller than the second diameter of the second pen.

15. A method of using a pen holder comprising:
providing the pen holder according to claim 1; and
alternately receiving and making sealing contact with at least a first pen having a first larger diameter and a second pen having a second smaller diameter.

16. The pen holder according to claim 5, wherein the pen cap stop is in the form of a step in the receiving space or in the form of at least one lug extending radially into the receiving space.
